(19) United States
(12) Patent Application Publication
(10) Pub. No.: US 2010/0269919 A1
(43) Pub. Date: Oct. 28, 2010

(54) AIR RECEIVER TANK WITH REMOVABLE TOP PLATES

(75) Inventor: Brian Stopka, Wentzville, MO (US)

Correspondence Address: FAY SHARPE LLP, 1228 Euclid Avenue, 5th Floor, The Halle Building, Cleveland, OH, 44115, US

(73) Assignee: Curtis-Toledo Inc.

(21) Appl. No.: 12/765,504

(22) Filed: Apr. 22, 2010

Related U.S. Application Data
(60) Provisional application No. 61/172,953, filed on Apr. 27, 2009.

(51) Int. Cl. F16L 3/00

(52) U.S. Cl. 137/376

(57) ABSTRACT

An air receiver tank and removable mounting plate assembly includes an air receiver tank having at least one mounting bracket secured thereto for removably mounting a mounting plate, wherein the bracket has holes. A mounting plate includes a top wall and first and second side walls extending from the top wall; wherein each of the first and second side walls includes holes. The mounting plate is removably secured to the air receiver tank via a plurality of fasteners received by the holes of the mounting brackets and corresponding holes of the mounting plate.

### CLAIM OF PRIORITY

This application claims priority from Provisional application Ser. No. 61/172,953 filed on Apr. 27, 2009, which is incorporated herein by reference.

### BACKGROUND OF THE DISCLOSURE

This disclosure relates to a mounting mechanism for an air compressor and drive motor on an air receiving tank and more particularly to a removable mounting plate or base for mounting a motor or a compressor to an upper surface of an air receiver tank in either a vertical or horizontal orientation.

Portable and stationary air compressors are used for many applications, including operating pressure feed tanks, spray guns, caulking guns, air brushes, sand blasters, pneumatic tools, tire inflaters, etc. Air compressors for these applications generally include a cylindrical air receiving tank, a belt-driven air compressor, and an electric motor or gasoline/diesel engine defined as the driver. In existing air compressors, a mounting platform typically is permanently welded either to the upper side of a horizontally-oriented tank or to the top of a vertically-oriented tank. The compressor and the motor are mounted on the platform, and a drive belt is provided to interconnect pulleys on the motor and the compressor. The motor generally is bolted through slots in the mounting platform, which allows for adjustment of the motor position toward and away from the compressor to adjust belt tension. Since the air receiving tank must withstand a high internal gas pressure, highly skilled welders are required for welding the mounting platform or base onto the tank to avoid weakening the tank at the welds. Also, in this existing construction, tension on the drive belt applies bending forces to the mounting platform which, in turn, stress the tank at the welds. These stresses fluctuate with changes in the compressor load, since both the motor and the compressor are rigidly bolted to separate locations on the mounting platform.

A problem with these existing mounting plates is that they are permanently welded to a particular air receiving tank and are committed to a dedicated tank for one application. Thus, a new plate must be provided for each tank application which increases cost and inventory. Furthermore, weld stresses may occur at the plate welds which may weaken the tank at the welds.

Thus, it is desirable to provide various configurations of mounting plates or bases which are removably attachable to air receiver tanks in either a horizontal or vertical orientation so the mounting plate can be reused or interchanged, thus reducing costs and inventory and eliminating weld stress problems with welded plates or bases.

### SUMMARY OF THE DISCLOSURE

The disclosure relates to an air receiver tank. More particularly, it relates to a mounting plate which is removably mounted to a top of the air receiver tank.

In accordance with one aspect of the disclosure, a mounting plate is removably fastened or otherwise secured to an air receiving tank, in either a vertical or horizontal position. A cylindrical air receiver tank accommodates a compressor, a motor, and controls. The tank may be supported at one end by a pair of wheels or by legs. A handle may be attached to the legs to facilitate moving the portable air receiver tank. A gauge is used for indicating the pressure within the air receiving tank; a pressure regulator for controlling the pressure at a compressed air outlet; a gauge for indicating the gas pressure at the outlet; an outlet valve; and a pressure responsive switch for turning the motor on and off. The controls may be attached to a flange which is welded to an outlet opening in the air receiving tank.

In accordance with another aspect of the disclosure, an air receiver tank and removable mounting plate assembly includes an air receiver tank having at least one mounting bracket secured thereto for removably mounting a mounting plate, wherein the bracket has holes; and a mounting plate including a top wall and first and second side walls extending from the top wall; wherein each of the first and second side walls has holes; wherein the mounting plate is removably secured to the air receiver tank via a plurality of fasteners received by the holes of the mounting brackets and corresponding holes of the mounting plate.

In accordance with another aspect of the disclosure, a removable mounting plate assembly for an air receiver tank has at least one mounting bracket secured to the air receiver tank, wherein the mounting bracket is substantially L-shaped and includes one or more openings therein; and a mounting plate which is removably secured to the mounting bracket; wherein the mounting plate includes first and second walls substantially parallel to each other and connected by a third wall extending between the first and second walls; wherein the first and second walls each has one or more openings; wherein the mounting plate is removably secured to the mounting bracket via a fastener extending through the one or more holes of the mounting bracket and through one of the one or more holes of the first and second walls.

Another aspect of the disclosure is that the mounting plate is removably secured to the air receiver tank and can be reused or interchanged with other tanks, thus reducing inventory and costs.

Another aspect of the disclosure is that the mounting plate is secured to an air receiver tank in a vertical orientation.

Yet another aspect of the disclosure is that the mounting plate is secured to the air receiver tank in a horizontal orientation.

Another aspect of the disclosure is that the mounting plate can extend beyond the length of the air receiver tank.

Still another aspect of the disclosure is that the mounting plate is mounted to a portable air receiver tank.

Still another aspect of the disclosure is the mounting plate can be removed from the tank and have a motor and compressor pre-assembled or installed thereon.

Yet another aspect of the disclosure is that a simplex mounting plate and a duplex mounting plate can be used on any of 30-, 60-, 80-, 120-, 200- or 240-gallon tanks.

Still other aspects of the disclosure will become apparent upon a reading and understanding of the following detailed description.

### BRIEF DESCRIPTION OF THE DRAWINGS

FIG. 1 is an exploded perspective view of an air receiver tank in a horizontal orientation and a simplex mounting plate in accordance with one aspect of the disclosure;

FIG. 2 is a perspective view of the air receiver tank and the mounting plate secured thereto of FIG. 1;

FIG. 3 is an exploded perspective view of a portable air receiver tank in a horizontal orientation and a simplex mounting plate in accordance with another aspect of the disclosure;

FIG. 4 is a perspective view of the portable air receiver tank and the mounting plate secured thereto of FIG. 3;

FIG. 5 is an exploded perspective view of an air receiver tank in a horizontal orientation and a duplex mounting plate in accordance with another aspect of the disclosure;

FIG. 6 is a perspective view of the air receiver tank and mounting plate secured thereto of FIG. 5;

FIG. 7 is an exploded view of an air receiver tank in a vertical orientation and a mounting plate in accordance with another aspect of the disclosure;

FIG. 8 is a perspective view of the air supply tank and the mounting plate attached thereto of FIG. 7; and

FIG. 9 is a side elevational view of a top plate and air receiver tank with a compressor and motor installed thereon.

### DETAILED DESCRIPTION OF THE DISCLOSURE

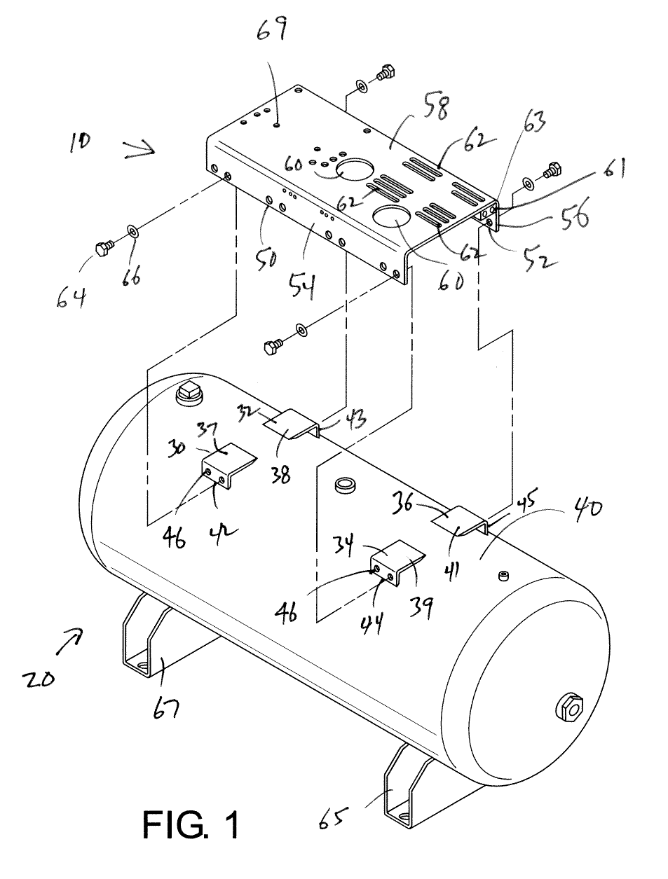

A cylindrical air receiver tank 20 is illustrated in FIG. 1 in accordance with a first embodiment of the present disclosure. The air receiver tank accommodates a belt driven air compressor, an electric or gasoline/diesel motor, and controls. The tank may be supported at one end by a pair of wheels or by legs. A handle may be attached to the legs to facilitate moving the portable air receiver tank. A gauge is used for indicating the pressure within the air receiving tank; a pressure regulator for controlling the pressure at a compressed air outlet; a gauge for indicating the gas pressure at the outlet; an outlet valve; and a pressure responsive switch for turning the motor on and off. The controls may be attached to a flange which is welded to an outlet opening in the air receiving tank.

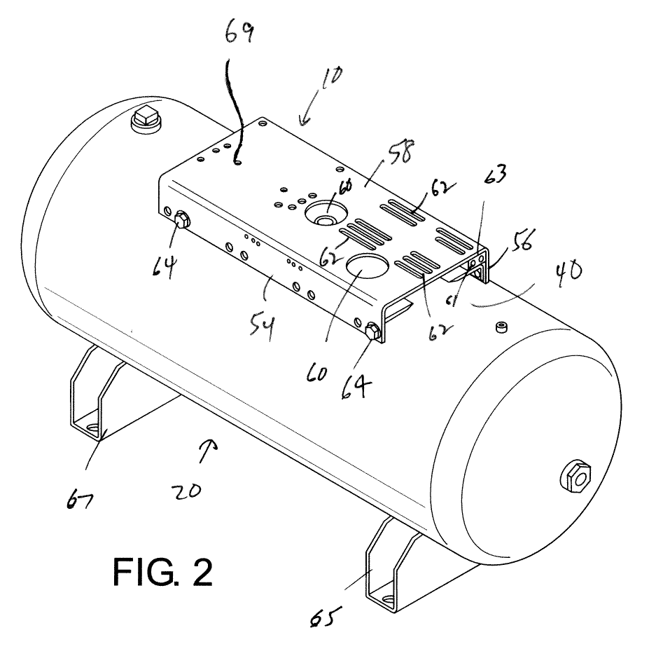

Referring specifically now to FIGS. 1 and 2, a horizontal simplex mounting plate 10 is bolted or otherwise secured to a top surface 40 of a horizontal air receiving tank 20. The mounting plate is made of metal, such as steel. In accordance with one aspect of the invention, two pairs of parallel spaced apart mounting brackets or flanges or bars 30, 32, 34, 36 are welded to opposed ends of top wall or surface 40 of the tank. Each bracket is substantially L-shaped having a first horizontal surface 37, 38, 39, 41 and a second vertical surface 42, 43, 44, 45 substantially perpendicular to the first surface. Each bracket has at least a pair of spaced apart holes 46 for aligning with corresponding pairs of spaced-apart holes 50, 52 formed in opposing walls 54, 56 formed in the plate 10. Brackets 30 and 32 are substantially parallel to each other, and brackets 34 and 36 are substantially parallel to each other.

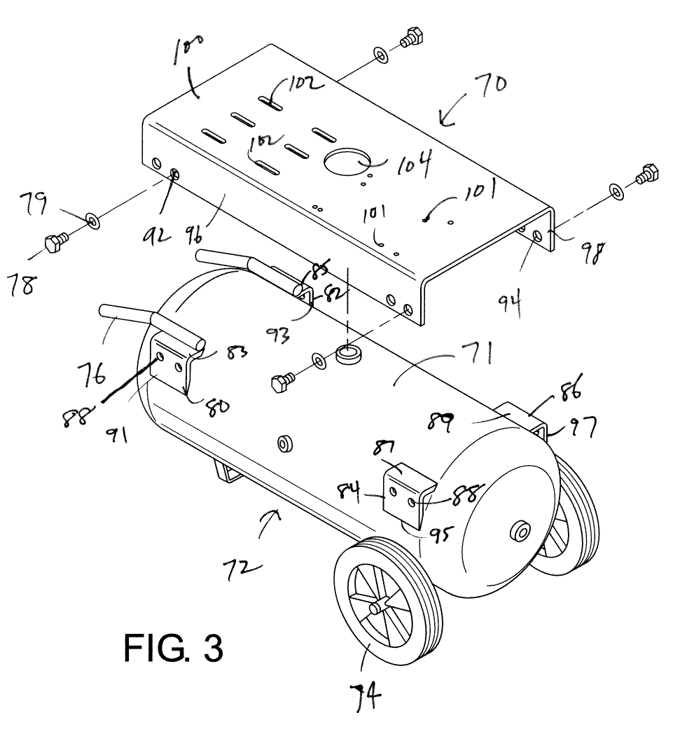

The plate further has a horizontal top wall 58 which extends between and connects the two end walls 54, 56. Walls 54, 56 are substantially parallel to each other and are perpendicular to upper wall 58. Top wall 58 of the plate has one or more circular or oval-shaped slots 60 formed therein and a plurality of elongated slots 62 which are parallel and spaced apart from each other. Slots 62 are used for mounting a motor to the tank. Multiple groups of two or three elongated slots 62 are formed in top plate 58. The slots 62 can vary in shape, length and number, depending on the use of the slots. For example, different slots 62 are used for accommodating a 10 horsepower engine as compared to a 15 horsepower engine. Slot 60 receives a line from an air compressor to the tank which in turn receives the compressed air. A motor take-up bracket 63 is welded or otherwise secured to the plate for receiving a bolt (not shown) through one of holes 61. The bolt is used to pull and tighten a belt used to secure the motor to the mounting plate. Bracket 63 can also be used with the plates shown in FIGS. 3-9. A series of holes 69 are formed in wall 58 of the mounting plate to secure a compressor to the plate. A single motor and compressor are mounted to the simplex plate. The plate can be used with any simplex air receiver tank such as 30-gallon, 60-gallon, 80-gallon, 120-gallon, 200-gallon or 240-gallon capacity tanks.

Tank 20 has at least a pair of base brackets or legs 65, 67 which support the air tank on a horizontal surface.

Referring now to FIG. 2, the top plate 10 is shown mounted to the air cylinder 20. A plurality of fasteners such as bolts or screws 64 and lock washers 66 are mounted through mating holes 46, 50, 52 of the plate and the air receiver tank. The plate 10 is used with compressors such as E57, D96, C79, ES30, ES50 and E50 model compressors.

Referring now to FIG. 3, a simplex mounting plate 70 can also be used with a portable air receiver tank 72 in the horizontal position. Tank 72 can be 23 gallons capacity or more such as 30-, 60-, 80-, 120-, 200- or 240-gallon capacity. In this configuration, tank 72 has wheels 74 and handles 76 which are used to push or move the portable tank by rolling wheels 74. The tank has four spaced apart mounting brackets 80, 82, 84, 86 which are substantially L-shaped with upper horizontal surfaces 83, 85, 87, 89 and vertical surfaces 91, 93, 95, 97 is welded or otherwise secured to the plate. Each bracket has holes 88 formed in vertical surfaces 91, 93, 95, 97 which align with holes 92, 94 in the plate 70.

Holes 92, 94 are formed in opposed vertical walls 96, 98 of plate 90. Plate 90 further has a horizontal top wall 100 which extends between walls 96, 98. Walls 96, 98 are parallel to each other and perpendicular to wall 100. Plate 70 has a plurality of elongated slots 102 which are used to mount a single motor to the tank. One or more circular or oval-shaped slots 104 receive a line from an air compressor to the tank which in turn receives the compressed air. A series of holes 101 are formed on wall 100 to accommodate installing a single compressor to the plate.

Two sets of three parallel slots 102 are shown, but other configurations of slots are contemplated by the disclosure. The slots on the mounting plates can vary in the shape, length and number depending upon the use for the slots. For example, different slots 102 are used for accommodating a 10 horsepower engine as compared to a 15 horsepower engine. Plate 70 extends to the opposite ends of the cylinder 72, but a longer or shorter plate is also contemplated.

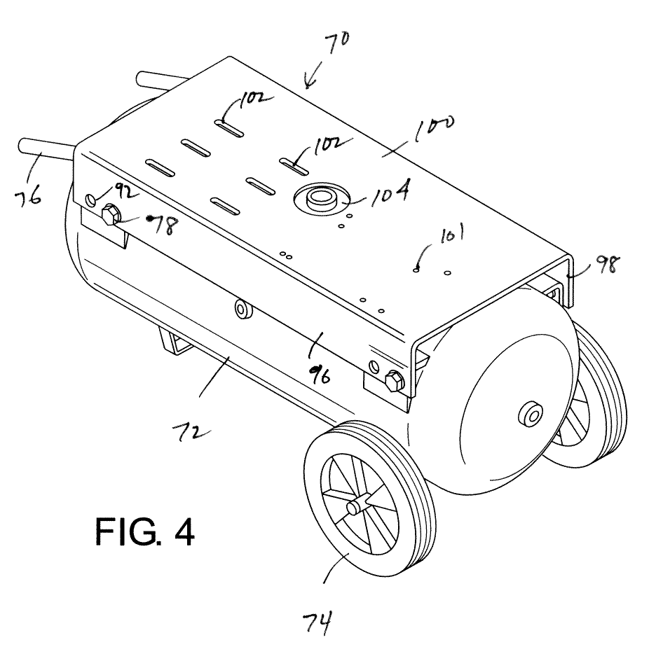

Referring now to FIG. 4, the plate 70 is mounted to upper surface 71 of the air cylinder 72 via a plurality of fasteners 78 and lock washers 79 which are attached to the plate and cylinder via mating holes 88 in bracket 80, 82, 84, 86 and holes 92, 94 in the plate 70.

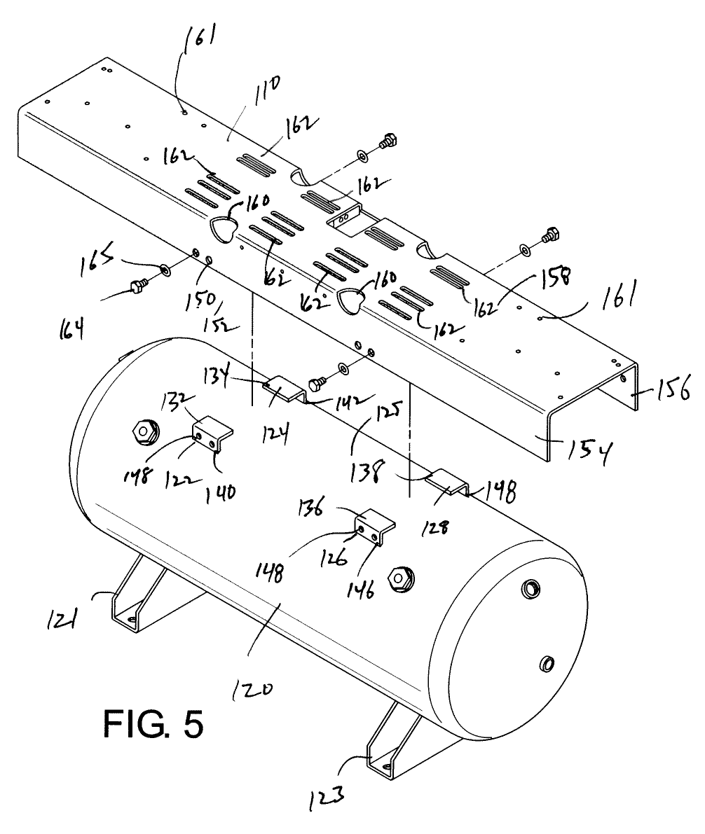

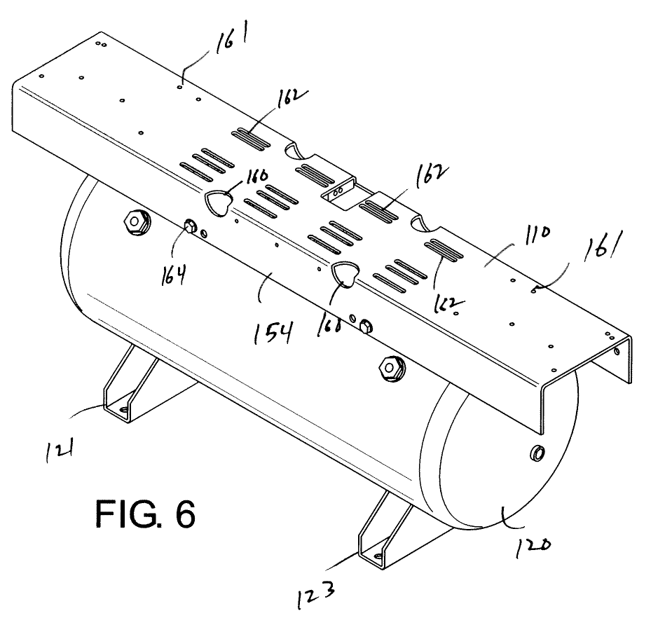

Referring now to FIGS. 5 and 6, a horizontal duplex mounting plate 110 is bolted or otherwise secured to a top surface of a horizontal air receiving tank 120. Two pairs of parallel spaced apart mounting brackets or flanges or bars 122, 124, 126, 128 are welded to a top wall or surface 130 of the tank. Each bracket is substantially L-shaped having a first horizontal surface 132, 134, 136, 138 and a second vertical surface 140, 142, 144, 146 substantially perpendicular to the first surface. Each bracket has a pair of holes 148 for aligning with corresponding holes 150, 152 formed in opposing walls 154, 156 formed in the plate 110. The plate further has a top wall 158 which extends between and connects the two end walls 154, 156. Walls 154, 156 are substantially parallel to each other and are perpendicular to upper wall 158. Top wall 158 of the plate has one or more circular or oval-shaped grooves 160 formed in both an edge of top plate 110 and one of the side plates 154, 156 and a plurality of elongated slots 162 which are parallel and spaced apart from each other. Slots 162 are used for mounting a pair of motors to the tank. Slots 160 receive a line from two air compressors to the tank which in turn receives the compressed air. Holes 161 are provided on the top surface 110 for accommodating a pair of compressors on the plate. The duplex plate can be used with 30-, 60-, 80-, 120-, 200- or 240-gallon capacity tanks. Tank 120 has at least a pair of base brackets or legs 121, 123 for supporting the tank on a horizontal surface.

Referring now to FIG. 6, the top plate 110 is shown mounted to a top surface 125 of the air cylinder 120. A plurality of fasteners 164 and lock washers 166 are mounted through mating holes 146, 150, 152.

The plate has a plurality of spaced apart holes 160 thereon, as well as a plurality of elongated, parallel slots 162. The slots on the mounting plates can vary in the shape, length and number depending upon the use for the slots. For example, different slots 162 are used for accommodating a 10 horsepower engine as compared to a 15 horsepower engine. Plate 110 can be used with E15 compressors with a 15 HP motor, and 081.2 compressors with 7.5 HP or 10 HP motors.

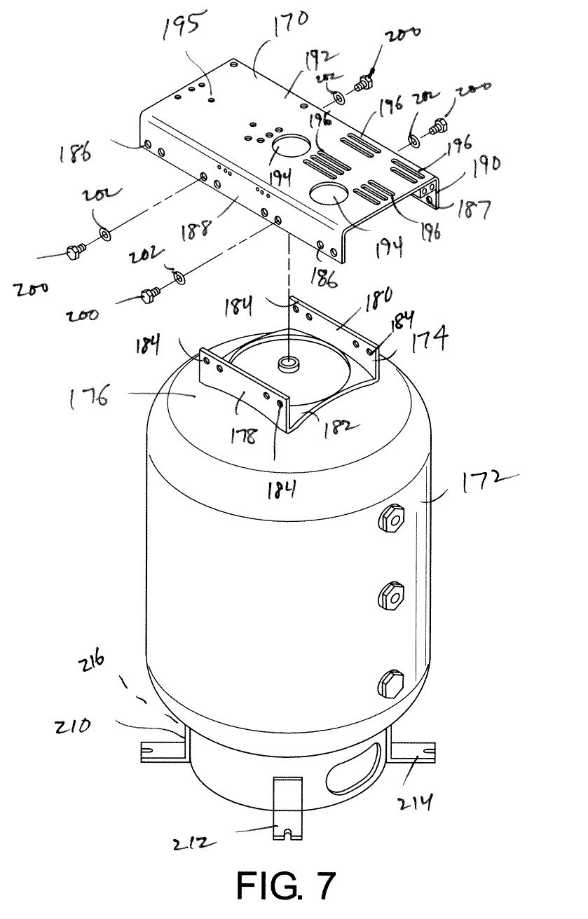

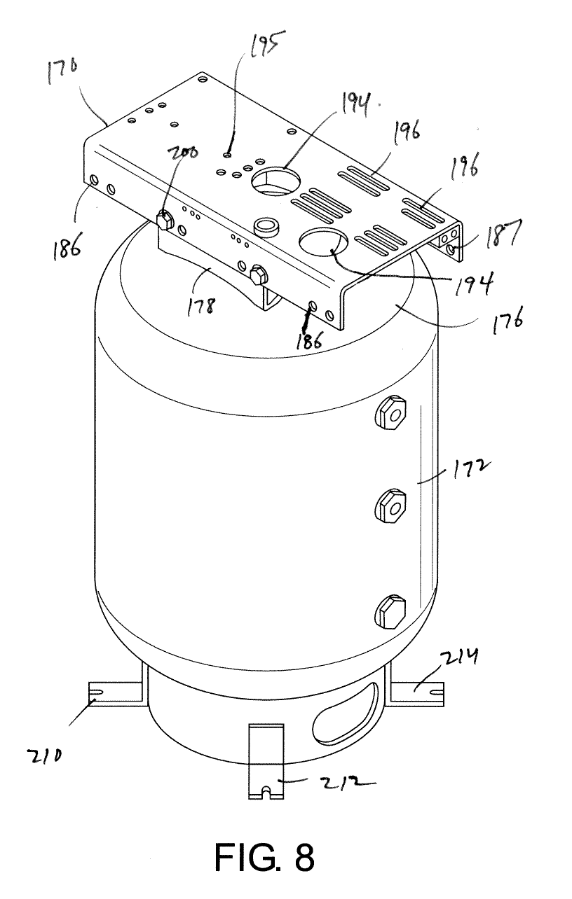

Referring now to FIGS. 7 and 8, a simplex mounting plate 170 is bolted or otherwise secured to a top surface of a vertical air receiving tank 172. A mounting bracket 174 is welded to a top wall or surface 176 of the tank. The bracket has a first vertical surface 178 and a second vertical surface 180 substantially parallel to the first surface. A third wall 182 extends between walls 178, 180 and is mounted to upper surface 176 of the tank. Wall 182 can have a curvature to correspond to the curvature of upper surface 176. The bracket walls 178, 180 each has a plurality of holes 184 for aligning with corresponding holes 186, 187 formed in opposing walls 188, 190 formed in the plate 170. The plate further has a top wall 192 which extends between and connects the two end walls 188, 190. Walls 188, 190 are substantially parallel to each other and are perpendicular to upper wall 192. Top wall 192 of the plate has one or more circular or oval-shaped slots 194 formed therein and a plurality of elongated slots 196 which are parallel and spaced apart from each other. Slots 196 can be grouped in sets of two or three parallel slots. Slots 196 are used for mounting a single motor to the tank. Slots 194 receive a line from a single air compressor to the tank which in turn receives the compressed air. Holes 195 are formed on the top surface 192 to accommodate a single compressor. The simplex plate can be used with 30-gallon, 60-gallon, 80-gallon or 120-gallon capacity vertical tanks

Referring now to FIG. 8, the top plate 170 is shown mounted to the air cylinder 172. A plurality of fasteners 200 and lock washers 202 are mounted through mating holes 184, 186, 187. Four legs 210, 212, 214, 216 (not shown) are mounted to the bottom portion of the tank. The legs can each be substantially L-shaped.

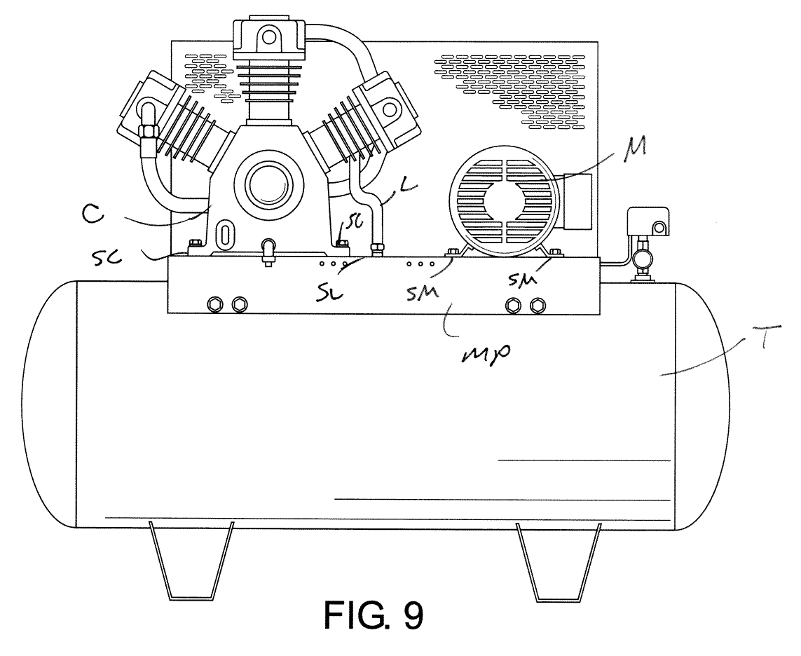

As seen in FIG. 9, a mounting plate MP is used to mount an air compressor C and an electric or gas motor M onto the air receiver tank T. The compressor has a line L which is fed into the air receiver tank which in turn stores the compressed air. Specifically, slots SM accommodate the motor, and slots SL accommodate the lines L from the compressor. Holes SC accommodate the compressor.

Various configurations of the mounting plates for air receiver tanks can be used for different arrangements and types of compressors and motors. Specifically, a base or plate can be used for E50, D96A, E57 compressors on a 30-gallon, 60- gallon, 80-gallon, 120-gallon, 200-gallon or 240-gallon tank or for ES30, ES50, E50, D96 and C79style compressors, or for 89, 97, E71 and ES100 compressors, or for E15 and ES150 compressors, or for ES05 and ES06 compressors. A plate can be used for a 15 horsepower motor for an E15for a 7-1/2 and 10 horsepower motor for a D81.2, or for 5 and 7 horsepower motors.

The various mounting bases or plates shown in FIGS. 1-9 may be used interchangeably with the various air receiver tanks.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An air receiver tank and removable mounting plate assembly, comprising:
an air receiver tank;
at least one mounting bracket attached to said air receiver tank for removably mounting a mounting plate to said air receiver tank, wherein said bracket comprises holes; and
said mounting plate comprising a top wall and first and second side walls extending from said top wall; wherein each of said first and second side walls comprises holes formed therein; wherein said mounting plate is removably secured to said air receiver tank via a plurality of fasteners received by said holes of said mounting brackets and said holes of said mounting plate.

2. The air receiver tank and removable mounting plate assembly of claim 1, wherein each of said mounting brackets is substantially L-shaped.

3. The air receiver tank and removable mounting plate assembly of claim 1, wherein said mounting plate is mounted to a top surface of said air receiver tank.

4. The air receiver tank and removable mounting plate assembly of claim 1, wherein said fastener comprises bolts and washers.

5. The air receiver tank and removable mounting plate assembly of claim 1, wherein said mounting plate comprises at least one slot for receiving a line from an associated air compressor.

6. The air receiver tank and removable mounting plate assembly of claim 5, wherein said slot is circular.

7. The air receiver tank and removable mounting plate assembly of claim 1, wherein said mounting plate comprises at least one elongated slot for receiving at least one motor on said mounting plate.

8. The air receiver tank and removable mounting plate assembly of claim 1, wherein said mounting plate comprises holes for accommodating at least one compressor.

9. The air receiver tank and removable mounting plate assembly of claim 1, wherein said air receiver tank is in a horizontal orientation.

10. The air receiver tank and removable mounting plate assembly of claim 1, wherein said air receiver tank is in a vertical orientation.

11. The air receiver tank and removable mounting plate assembly of claim 1, wherein said mounting plate extends beyond an upper surface of said air receiver tank.

12. The air receiver tank and removable mounting plate assembly of claim 1, wherein said first and second side walls of said mounting plate are substantially parallel to each other and are substantially perpendicular to said top wall of said mounting plate.

13. The air receiver tank and removable mounting plate assembly of claim 1, wherein at least one mounting bracket comprises two pairs of mounting brackets, wherein each of said mounting brackets comprises a pair of holes.

14. The air receiver tank and removable mounting plate assembly of claim 13, wherein each of said two pairs of mounting brackets comprises two brackets which are substantially parallel to each other.

15. The air receiver tank and removable mounting plate assembly of claim 1, wherein said at least one mounting bracket comprises first and second walls which are substantially parallel to each other and a third wall which extends between said first and second walls.

16. The air receiver tank and removable mounting plate assembly of claim 1, wherein said mounting plate comprises a bracket having a hole therein for accommodating a bolt for tightening a motor to said plate.

17. A removable mounting plate assembly for use with an air receiver tank, comprising:
at least one mounting bracket secured to said air receiver tank, wherein said mounting bracket is substantially L-shaped and comprises one or more openings formed therein;
and a mounting plate which removably secured to said mounting bracket; wherein said mounting plate comprises first and second walls substantially parallel to each other and connected by a third wall extending between said first and second walls; wherein said first and second walls each comprises one or more openings; wherein said mounting plate is removably secured to said mounting bracket via a fastener extending through said one or more openings of said mounting bracket and through one of said one or more openings of said first and second walls.

18. The removable mounting plate assembly of claim 17, wherein said fastener comprises a bolt and a washer.

19. The removable mounting plate assembly of claim 17, wherein said mounting plate comprises at least one slot for receiving a line from an associated air compressor.

20. The removable mounting plate assembly of claim 19, wherein said slot is circular.

21. The removable mounting plate assembly of claim 17, wherein said mounting plate comprises at least one elongated slot for receiving at least one motor on said mounting plate.

22. The removable mounting plate assembly of claim 17, wherein at least one mounting bracket comprises a pair of mounting brackets, wherein each of said mounting brackets comprises a pair of openings and said mounting brackets are substantially parallel to each other.

23. The removable mounting plate assembly of claim 17, wherein said mounting plate comprises holes for accommodating at least one compressor.

24. The removable mounting plate assembly of claim 17, wherein said mounting plate comprises a bracket for accommodating a bolt for tightening a motor to said plate.
